(19) United States
(12) Patent Application Publication
(10) Pub. No.: US 2007/0117079 A1
(43) Pub. Date: May 24, 2007

(54) System and method for media delivery

(76) Inventors: Robert Budlow, Chatham, NJ (US); Rick Toone, Doylestown, PA (US); Mark Smith, Doylestown, PA (US)

Correspondence Address: SOFER & HAROUN LLP., 317 MADISON AVENUE, SUITE 910, NEW YORK, NY, 10017, US

(21) Appl. No.: 11/446,591

(22) Filed: Jun. 2, 2006

Related U.S. Application Data
(60) Provisional application No. 60/686,964, filed on Jun. 2, 2005.

(51) Int. Cl. G09B 5/00

(52) U.S. Cl. 434/317

(57) ABSTRACT

A method is provided for digitally presenting physical media content including obtaining a physical media content having a plurality of pages, each page having at least one visual aspect and one audible aspect. For each page, rendering the visual aspect into a digitally stored visual file component. For each page, rendering the audible aspect into a digitally stored audio file component. For each page, associating the visual file component with the audio file component for each page. Storing the associated visual and audio file components for each of the pages into a single digital media file representing the physical media content as a digital media file. Placing the digital media content file in a format for storage and playback in a viewing device.

### RELATED APPLICATION

This application is related to and claims the benefit of priority from U.S. Provisional Patent Application No. 60/686,964, filed on Jun. 2, 2005, the entirety of which is incorporated herein by reference.

### FIELD OF THE INVENTION

The present invention relates to a system and method for media delivery. More particularly, the present invention relates to a system and method for digitally presenting physical media content.

### BACKGROUND

Currently, the market for digital media device is primarily dominated by video game, DVD, and music content. Such devices provide hours of entertainment to both adults and children. Also, with the rise of mobile digital media devices, users can now not only view the digital content at home but can just as easily take such content on the road. In the case of parenting, these mobile digital devices are useful to keep children occupied during riving or other such tasks which require their concentration like shopping. However, the typical content of digital media tends to be mindless entertainment oriented. Obviously, fixed location digital devices can be used similarly by parents when cleaning or performing other home chores.

One alternative to such devices is to use books, however, they are much more substantial in size than typical mobile gaming devices in travel situations, and are not as attractive to some children who in many cases prefer the newer digital media format.

### OBJECTS AND SUMMARY

The present invention looks to overcome the drawbacks associated with the prior art and provide a system and method for taking preexisting physical media content such as books, and convert them to a format for playback on digital devices such as mobile digital devices.

Furthermore, the system and method of the present invention advantageously presents or reads the book to the user, keeping the feel of book, rather than that of a video or continuous playing file.

To this end, the present invention is directed to a method for digitally presenting physical media content by obtaining a physical media content having a plurality of pages, where each page has at least one visual aspect and one audible aspect. For each page of physical media content, the visual aspect is rendered into a digitally stored visual file component corresponding to each of the pages and likewise for each page of the physical media content, the audible aspect is rendered into a digitally stored audio file component corresponding to each of the pages.

For each page of the physical content, the visual file component and the audio file components are associated with one another for each page and stored into a single digital media file representing the physical media content as a digital media file. The digital media content file is stored in a format for storage and playback in a viewing device.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is an illustration of a typical physical media content, in accordance with one embodiment of the present invention;

FIG. 2 is a block diagram of the components of a physical to digital conversion system, in accordance with one embodiment of the present invention;

FIG. 3 is a flow chart for converting the physical media content from FIG. 1 into a digital media file, in accordance with one embodiment of the present invention;

FIG. 4 is a user media playback device for playing the digital media file, in accordance with one embodiment of the present invention; and

FIG. 5 is flow chart for playing the digital file on the playback device from FIG. 4, in accordance with one embodiment of the present invention.

### DETAILED DESCRIPTION

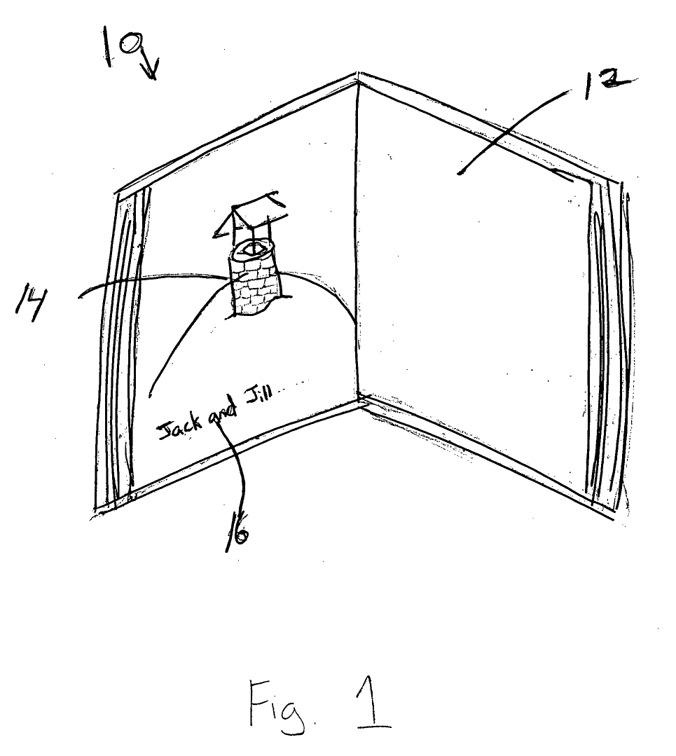

The system and method of the present invention is configured to convert a physical media content into a digital media file for viewing on digital playback device, such as a personal mobile digital device. To this end, as illustrated in FIG. 1, a physical media content 10 is shown in the form of a standard book. It is understood that any physical media content such as pamphlets, brochures, comic books etc. . . . may be converted for to a digital media file via the present invention. For illustrative purposes however, book 10 is referred to throughout interchangeably with physical media content 10.

As shown in FIG. 1, book 10 maintains a plurality of pages 12 each of which have a visual aspect 14 and an audible aspect 16. Visual aspect 14 refers to any images contained on the page and audible aspect 16 generally refers to any text that may be read. The present invention contemplates that children's books, which have many visual aspects 14 to accompany the audible content 16, are the focus of the system and method of the present invention, as many adult books only have an audible content 16. However, the invention is not limited in this respect.

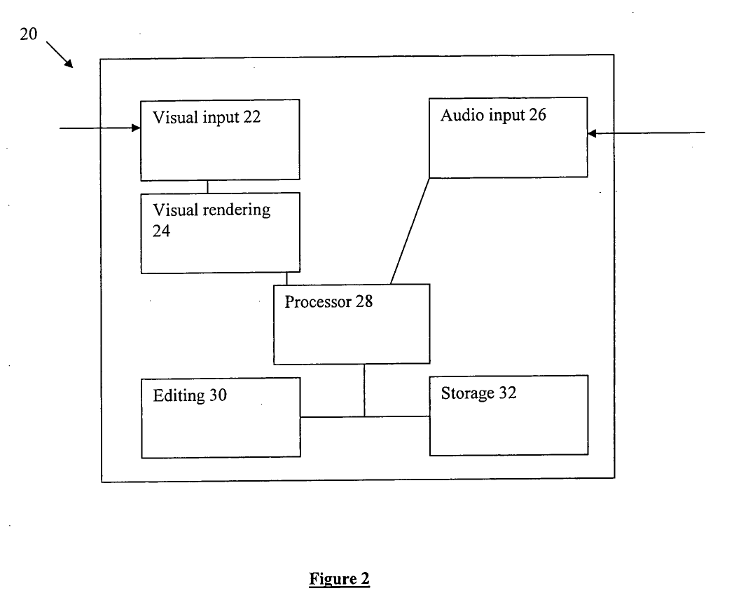

In one embodiment of the present invention, as illustrated in FIG. 2, the physical to digital conversion system 20 (referred to hereinafter as system 20), maintains a visual input module 22, an audio in put module 26, a visual rendering module 24, a processor 28, editing module 30, and a storage module 32.

Visual input module 22 is configured to receive visual aspects 14 from book 10. This can be done by scanning the pages 12 of book 10 via a typical scanner. Alternatively, digital representations of visual aspects 14 of page 12 may be directly imported on-line from outside or third party source such as a publisher or writer. Any additional methods of inputting physical images to digital format are also within the contemplation of the present invention. Visual rendering module 24 is configured to render the imported visual aspects 14 of page 12 into an accessible and storable format.

Audio input module 26 is configured to receive audio input, such a voice over input via a microphone or other such sound collection device. This audio input corresponds to the audible aspect 16 of pages 12 of book 10. Audio module 26 is preferably outfitted with some form of editing software allowing the operator of system 20 to place the generated audio files into some manageable format. Ideally, audible aspects 16 input through audio input module 26 and visual aspects 14 input via visual input and visual rendering modules 22 and 24 are in compatible or even the same format (program).

Processor module 28 is configured to generate a digital media file corresponding to the physical media content 10 (book 10) using the input from audio input, visual input and visual rendering modules 22, 24 and 26. In one embodiment of the present invention, processor 28 is configured such that for each page 12 of book 10, the input visual aspects 14 are correlated with the corresponding audible aspects 16. This data can be stored in storage module 32. Once each page 12 of book 10 is stored, processor 28 is further configured to generate a single digital media file that corresponds to the entire physical media content 10.

The digital media file generated by system 20 for book 10 may be in any available format that stores combined audio and visual components including but not limited to .mov, H264, . mp4, wmv, 0.3 gp, etc. . . .

In one embodiment of the present invention, processor 28 is further configured to insert a ring, bell, or tone noise instruction between each page 12 stored in the digital media file for book 10. As explained below, when a user views the digital media file and changes pages, the user will hear the tone to let them know that the current view is literally from a different page 12 from the original physical media content than from the previously viewed page 12.

Likewise, processor 28, is further configured to insert a page flipping image/animation instruction between each page 12 stored in the digital media file for book 10. As explained below, when a user views the digital media file and changes pages, the user sees the flipping page image to let them know that the current view is literally from a different page 12 from the original physical media content 10 than the previously viewed page 12. These characteristics assist in generating the feel of reading an actual book rather than viewing a movie or cartoon, even though it is being viewed on a personal digital device.

Editing module 30 is configured to allow a user to review the digital media file created from book 10, allowing each page 12 view to be edited or re-mastered to enhance stored visual and audible aspects 14 and 16 to ensure that they look as close to page 12 of book 10 as possible and that the audible aspect 16 matches the stored audio portion of the file for that page 12. Furthermore, editing module 12 can also be used to insert certain embellishments such as background music or sound effects to accompany each page view.

To form the digital media file, processor 28 and editing module 30 may employ such programs as Flash, Pinnacle, Premier, Final Cut, Windows Movie Maker etc., although any similar editing and program creation software may be employed.

It is understood that the above modules and descriptions for system 20 are intended only as exemplary modules to illustrate the salient features of the invention. For example, any of the various modules may be combined or further subdivided for performing their functions and such modules may be implemented as either hardware or software. Furthermore, modules such as storage module 32 may be located off-site or handled by third party vendors. It is shown above only to illustrate its function within system 20. It is understood that the present invention contemplates any system 20 that employs similar functional modules to perform similar tasks as described below.

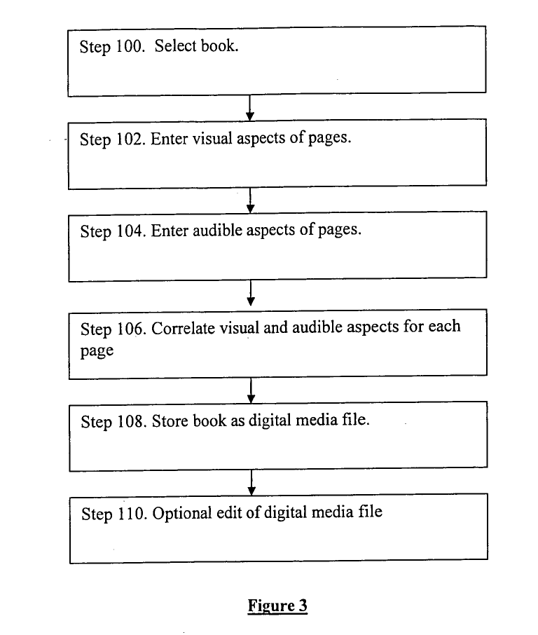

Thus, according to one embodiment of the present invention, as illustrated in FIG. 3, the process for converting book 10 into a digital book file via system 20 begins at step 100 where a user selects a book 10 to be converted into a digital media file. At step 102, the visual aspect 14 of each page 12 is entered into system 20 via visual input and visual rendering modules 22 and 24. At step 104, the audible aspects 16 are added (by way of voice over recordings etc. . . . ) by way of audio input module 26.

At step 106, processor 28, for each page 12 of original book 12, correlates the visual and audible aspects 14 and 16 to one another. Next, at step 108, processor 28 collects the correlated visual and audible aspects 14 and 16 from each page 12 and stores it in storage module 32 as a single digital media file that corresponds to book 10. Optionally, at step 110, the user may use editing module 30 to review the file to re-master any of the visual or audible aspects 14 and 16 from pages 12 or to add background music or sound effects to the file.

It is understood that the above description of the generation of a digital media file from book 10 is by way of example only. Any similar process using similar components from system 20 is within the contemplation of the present invention.

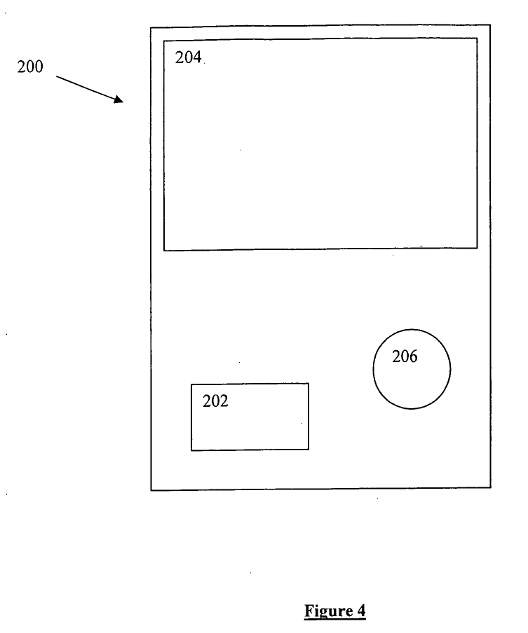

Turning now to the viewing of the digital media file of book 10, in one embodiment of the present invention, as illustrated in FIG. 4, a user has a digital playback device 200, such as a mobile viewing device having a storage module 202, a viewer 204 and an interface 206. It is contemplated that digital playback device can be any one of televisions, computers, personal video players, gaming devices, pocket computers/PDA'a, mobile phones, automobile entertainment centers and others. Furthermore, it is contemplated that device 200 employ a program that can run digital audio/visual files, including but not limited to Windows Media, Real Player, Quicktime, Flash, and other such programs.

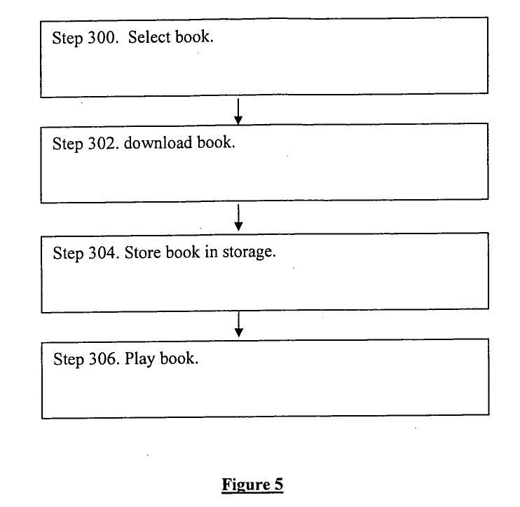

The operation of such device 200 begins at step 300, illustrated in FIG. 5, where by the user contact system 20 or some or some other secondary host of the digital media files and selects a book 10. At step 302, device 200 is then given the information via upload from a physical media or through download from the internet or other wireless communication. The present invention contemplates that the digital media file for book 10 may communicated to playback device by way of, but not limited to mobile streaming, mobile on demand, satellite streaming, satellite on demand, Internet streaming, Internet on demand, and hard media, including but not limited to CD, DVD, CF, SD. At step 304, the digital media file for book 10 is stored in storage module 202.

Next, at step 306, the user access the digital media file for book 10 and selects a playback mode. An example of a first playback mode is a continuous mode where each page 12 of book 10 is displayed for a pre-defined time and then the next page is automatically cued up. Alternatively, a non-continuous manual mode may be selected whereby the user can first initiate a digital media file for book 10 and then each successive page 12 turn is initiated through some interaction with interface 206. This process is repeated until book 10 is finished or the viewer interrupts viewing via interface 206.

It is understood that the above description of the viewing of a digital media file from book 10 is by way of example only. Any similar process using similar components is within the contemplation of the present invention.

As such, the present invention contemplates a system and method for converting a book or other physical media content 10 into a digital format using system 20. Viewers may then purchase the books 10 and download them to their viewing devices 200. The digital file plays to the viewer with the feel of a real book, rather than as a typical digital file such as a movie or cartoon. Such books 10 can be purchased by the user for a fee or advertisements may be added before the content of the digital media file by a sponsor so that the file may be downloaded for free by the viewer.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for digitally presenting physical media content, said method comprising the steps of:
obtaining a physical media content, said physical media content having a plurality of pages, each of said page having at least one visual aspect and one audible aspect;
for each page of said physical media content, rendering said visual aspect into a digitally stored visual file component corresponding to each of said pages;
for each page of said physical media content, rendering said audible aspect into a digitally stored audio file component corresponding to each of said pages;
for each page of said physical media content, associating said visual file component with said audio file component for each page;
storing the associated visual and audio file components for each of said pages into a single digital media file representing said physical media content as a digital media file; and
placing said digital media content file in a format for storage and playback in a viewing device.

2. The method as claimed in claim 1, wherein said step of rendering said visual aspect into a digitally stored visual file component is performed by scanning said page of said physical media content.

3. The method as claimed in claim 2, further comprising the step of re-mastering said digitally stored visual file component is performed after scanning to correct for clarity and color against the original visual aspect of said page.

4. The method as claimed in claim 1, wherein said step of rendering said audible aspect into a digitally stored audio file component is performed by voice over recording of said audible content.

5. The method as claimed in claim 1, wherein said step of storing the associated visual and audio files for each of said pages into a single file representing said physical media content as a digital media content file further comprises the step of adding an instruction to said mobile viewing device to insert a tone upon changing between each successively viewed page.

6. The method as claimed in claim 1, wherein said step of storing the associated visual and audio files for each of said pages into a single file representing said physical media content as a digital media content file further comprises the step of adding an instruction to said mobile viewing device to insert a digital image of a simulated page turn upon changing between each successively viewed page.
